(19) United States
(12) Patent Application Publication
(10) Pub. No.: US 2020/0355596 A1
(43) Pub. Date: Nov. 12, 2020

(54) AIRFLOW CONTROL FOR PARTICULATE SENSOR

(71) Applicant: HONEYWELL INTERNATIONAL INC., Morris Plains, NJ (US)

(72) Inventors: Kevin CAI, Shanghai (CN); Kai HUANG, Shanghai (CN); Marilyn WANG, Shanghai (CN); Wesley NIE, Shanghai (CN)

(21) Appl. No.: 16/640,876

(22) PCT Filed: Aug. 24, 2017
(86) PCT No.: PCT/CN2017/098888

§ 371 Date: Feb. 21, 2020

(51) Int. Cl. G01N 15/06

(52) U.S. Cl. CPC G01N 15/06; G01N 2015/0046; G01N 2015/0693

(57) ABSTRACT

A device (100) includes a flow channel (115) having a first end (120) to receive fluid flow (122) and a second end (125) to exhaust fluid flow (127), the flow channel (115) having a flow channel opening (135). A piston (130) is disposed within the flow channel (115), the piston (130) having a piston passage (140) to allow airflow through the piston (130). A spring (132) is coupled to the piston (130) and coupled to the flow channel (115). The spring (132) is positioned to allow the piston (130) to move responsive to fluid flow velocity in the flow channel (115), wherein the piston (130) moves to modulate fluid flow through the flow channel opening (135).

### BACKGROUND

Many air cleaners and fresh air systems require measurements of particulate matter of 2.5 μm (PM2.5 indication). The measurement of particulate matter can be used to ensure proper operation of the air cleaners. To achieve such measurements, manufacturers usually embed a dust sensor inside the machine.

Many infra-red sensors are adversely affected by varied airflow. While a fan can maintain a constant flow within the sensor detection zone, not all such sensors have fans. A common method of solving this is to place the sensor in a tiny confined place at the back of the air cleaner, leaving a few slices or grids of openings to let the natural air in. It is a critical drawback that the natural airflow is variable, so the particle sampling is not very effective.

### SUMMARY

A device includes a flow channel having a first end to receive fluid flow and a second end to exhaust fluid flow, the flow channel having a flow channel opening. A piston is disposed within the flow channel, the piston having a piston passage to allow airflow through the piston. A spring is coupled to the piston and coupled to the flow channel. The spring is positioned to allow the piston to move responsive to fluid flow velocity in the flow channel, wherein the piston moves to modulate fluid flow through the flow channel opening.

A system includes an air cleaner to clean air in an airflow through the air cleaner, a flow channel having a first end to receive airflow and a second end to exhaust fluid flow, the flow channel having a flow channel opening positioned in the airflow through the air cleaner, a piston disposed within the flow channel, the piston having a piston passage to allow airflow through the piston, and a spring coupled to the piston and coupled to the flow channel, the spring positioned to allow the piston to move responsive to airflow velocity in the flow channel, wherein the piston moves to modulate airflow through the flow channel opening.

A method includes receiving variable velocity air flowing through an air cleaner, modulating the velocity of the received variable velocity air to provide substantially constant velocity air to a particulate matter sensor, sensing the particulate matter in the substantially constant velocity air, and returning the constant velocity air to the air cleaner.

### BRIEF DESCRIPTION OF THE DRAWINGS

FIG. 1 is a block diagram of a device for regulating airflow velocity for a particulate matter sensor according to an example embodiment.

FIG. 2 is a perspective block diagram of a device for regulating airflow velocity for a particulate matter sensor according to an example embodiment.

FIG. 3 is a block diagram of an air cleaner incorporating a device for regulating airflow velocity for a particulate matter sensor according to an example embodiment.

FIG. 4 is a flowchart illustration of a method of regulating airflow velocity for a particulate matter sensor according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

Many air cleaners and fresh air systems measure a particulate matter of 2.5 μm (PM2.5 indication) or larger. The measurement of particulate matter can be used to ensure proper operation of the air cleaners. To achieve such measurement, manufacturers usually embed a dust sensor inside the machine. There are two types of dust sensors on the commonly used. One is the infra-red based that has a cost advantage but is susceptible to airflow variations, the other is laser type sensor that is more accurate, less susceptible to airflow variations, but more expensive.

Many infra-red sensors do not have a fan to maintain a constant airflow within the sensor's detection zone. A common method of solving this is to place the sensor in a tiny confined place at the back of the machine, leaving a few slices or grids of openings to let the natural air in. It is a critical drawback that the natural air is variable, so the particle sampling is not very effective.

In some air cleaners, manufacturers use the air cleaner internal flow to provide a necessary amount of air volume to the sensor. In such implementations, the sensor resides inside the internal flow channel of the machine. However, during machine on time, the flow speed is adjusted, so the speed of airflow inside the sensor is also affected, causing inaccurate particulate matter measurements.

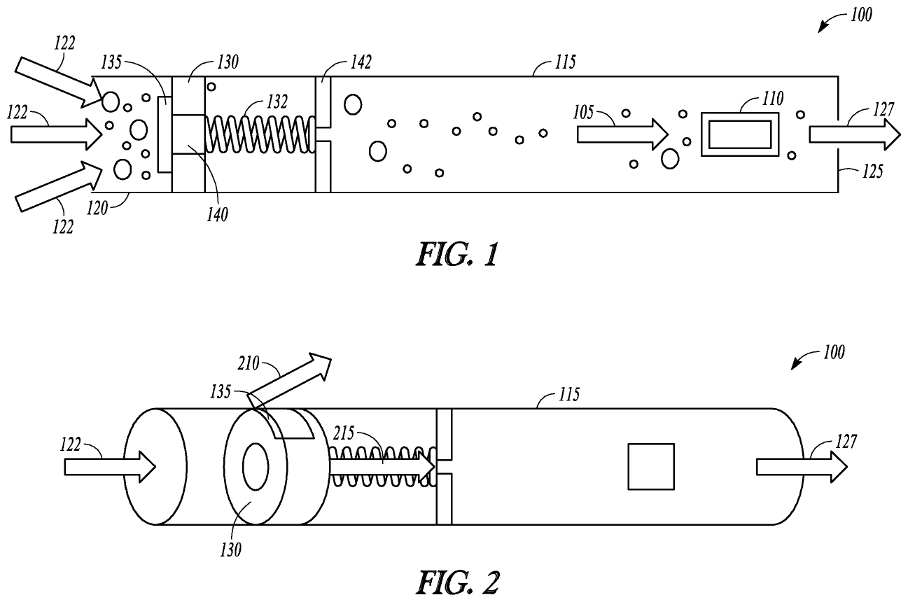

FIG. 1 is a cross section of a device 100 to provide fairly constant flow, such as airflow represented at arrow 105 to a particulate matter sensor, referred to as a dust sensor 110 (indicating PM2.5 concentration for example). Device 100 may include a flow channel 115, such as a pipe which is intended to be inserted into an air cleaner. The flow channel 115 has a first end 120 that receives air flowing (represented by arrows 122) through the air cleaner and a second end 125 that exhausts the received air, represented by arrow 127. The dust sensor 110 is supported in the flow channel 115 to receive the airflow.

The velocity of the airflow through the airflow channel 115 is modulated via a moveable light weight piston 130 that is placed between the first end 120 and second end 125 of the airflow channel 115, and upstream of the dust sensor 110. The piston 130 may be moveably supported by a spring mechanism 132 to allow the piston 130 to move laterally through the airflow channel 115. The piston 130 moves in the flow channel 115 responsive to the velocity or pressure of the airflow to modulate the airflow. An opening 135 in the airflow channel 115 is positioned proximate the piston to exhaust air from the airflow channel 115 when the piston is only partially covering the opening 135.

Responsive to a higher airflow velocity/pressure than desired, the piston moves toward the second end 125 of the airflow channel 115 such that more air is exhausted through the opening 135. When the airflow velocity is within a desired range, the piston moves to cover most or all of the opening 135 such that little to no air is exhausted through the opening. These actions module the airflow velocity at the sensor 110 to be fairly constant.

In one embodiment, the opening 135 is in the shape of a curved rectangle, following the shape of the airflow channel 115. Other shapes may be used in further embodiments provided the shape is compatible with suitable modulation of the piston to maintain a desired airflow velocity through the airflow channel 115. For instance, a trapezoidal shape may be used in conjunction with a spring having a variable spring constant of a range of compression of the spring.

In one embodiment, the piston 130 is centrally hollow, forming a passage 140 through the piston to allow air to flow between the first and second ends 120, 125 of the airflow channel 115. The passage 140 may be a cylindrical opening in the center of the piston 130 in some embodiments, or may take other cross sections, such as polygonal in further embodiments. The spring 132 also contains a passage to allow airflow through the spring.

The spring 132 may be supported by a plate 142 fixedly coupled to the airflow channel. Plate 142 also contains an opening to allow airflow. The plate 140 may have a washer type shape in some embodiments. The spring 132 may be retentively coupled to the plate 142 and piston 130 in some embodiments, or may simply be positioned with respect to each other such that airflow keeps each in suitable contact for allowing the piston to move responsive to airflow pressure, which is higher with higher airflow velocity. The spring constant of the spring 132 may generally have a loose elastic factor that may be determined empirically for each embodiment to maintain constant velocity airflow responsive to changes in inlet airflow velocity/pressure.

When the airflow from inlet increases, the piston is pushed toward second end 125 and the spring is compressed. The opening 135 which was previously blocked by the piston 130 is gradually open. With a branch of airflow leaking out of the opening, the airflow pressure will drop and the wind or airflow speed will remain relatively constant ahead of the sensor. One example of inlet air pressures varies from 7.8-10 pa in one example, with the constant velocity airflow ranging from 2.8 m/s to 2.77 for such pressures respectively. The inlet air pressures may vary further in further embodiments.

FIG. 2 is a perspective block diagram of the device 100, better illustrating the opening 135, airflow out the opening 210 and airflow through the piston 130. Variables used in the equation below are also represented in FIG. 2.

An equation set may be used to design mechanical dimensions:

v₁A₁=v₂A₂+v₃A₃

½ρv₁²A₁=½ρv₂²A₂+½ρv₃²A₃

½ρv₁²(A₁−A₂)=kx

[symbol]

A₃=xL

Where v₁ is the inlet flow velocity at 122, A₁ is the inlet area at end 120, A₂ is the piston hollow part 140 area, ρ is the standard air density, L is the opening 135 width. k is the spring 132 coefficient. The above may be preset and known.

The following may be modified to obtain desired characteristics. v₃ (shown at 210) is the velocity of the flow leaking out of the opening 135. v₂ (shown at 215) is the velocity of the flow passing through the piston hollow part 140. x is the distance that the spring 132 is compressed due to wind pressure. A₃ is the opening 135 area which is the product of xL.

In one example embodiment, the airflow channel 115 may be 20-30 cm in length. The opening 135 may be about 3×3 cm for example, with the piston being about 3 cm or longer in length to cover the opening at lower air pressures. The materials used may be metal or plastic. There is no need for a lubricant in some embodiments. In some embodiments, the desired airflow velocity may be maintained at approximately 3 meters per second in one embodiment, or may be maintained at a velocity of between 2 to 5 meters per second at the sensor 110 in further embodiments. The passage 140 through the piston 130 may be 1 cm to 1.5 cm in some embodiments, which may be sufficient to block larger particles.

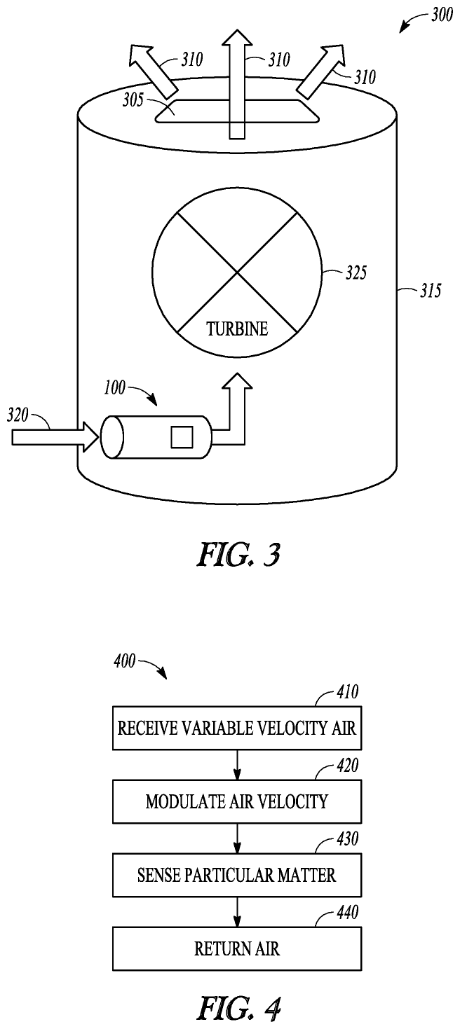

FIG. 3 is a perspective block diagram of an air cleaner 300 drawing in air to be cleaned, cleaning the air via filter devices 305, and exhausting clean air at 310. Device 100 may be placed within a body 315 of the air cleaner and also receives air to be cleaned at 320. Airflow represented at 320 may be received from a main air intake opening, or a separate opening to ambient air dedicated to device 100. A turbine/fan 325 may be positioned within body 315 to draw ambient air to be cleaned into the body 315. Since the turbine may vary its speed, different velocity/pressure of air may be experienced by device 100, and modulated by device 100 as described above such that a particulate sensor within device 100 may receive a fairly constant velocity of ambient air for which to measure particulate matter.

FIG. 4 is a flowchart of a method 400 of providing substantially constant velocity airflow to a particulate sensor. Method 400 includes receiving variable velocity air flowing through an air cleaner at 410. The velocity of the received variable velocity air is modulated at 420 to provide substantially constant velocity air to a particulate matter sensor. At 430, the particulate matter in the substantially constant velocity air is sensed. The constant velocity air is returned to the air cleaner at 440.

In one embodiment, modulating the velocity of the received variable velocity air includes moving a hollow piston responsive to an air pressure of the received variable velocity air, exposing the variable velocity air to an opening responsive to moving of the piston, exhausting variable velocity air via the exposed opening, and providing the substantially constant velocity air through the hollow piston to the particulate matter sensor. The hollow piston may move responsive to a spring coupled to the hollow piston. Variable velocity air with a higher pressure moves the piston further to expose more of the opening to exhaust more variable velocity air.

### EXAMPLES

1. A device comprising:

a flow channel having a first end to receive fluid flow and a second end to exhaust fluid flow, the flow channel having a flow channel opening;

a piston disposed within the flow channel, the piston having a piston passage to allow airflow through the piston; and

a spring coupled to the piston and coupled to the flow channel, the spring positioned to allow the piston to move responsive to fluid flow velocity in the flow channel, wherein the piston moves to modulate fluid flow through the flow channel opening.

2. The device of example 1 wherein the piston moves responsive to the fluid flow velocity to maintain exhaust fluid flow velocity within a desired range.

3. The device of any of examples 1-2 wherein the piston moves responsive to higher velocity fluid flow to cover less of the flow channel opening such that more fluid flows out the flow channel opening.

4. The device of any of examples 1-3 wherein the piston moves responsive to lower velocity fluid flow to cover more of the flow channel opening such that less fluid flows out the flow channel opening.

5. The device of any of examples 1-3 and further comprising a particulate matter sensor supported in the flow channel proximate the second end such that the particulate matter sensor is in the exhaust fluid flow.

6. The device of example 5 wherein the particulate matter sensor is an infra-red based particulate matter sensor for sensing at least 2.5 μm particles.

7. The device of example 5 wherein the particulate matter sensor is a laser based particulate matter sensor for sensing at least 2.5 μm particles.

8. The device of any of examples 1-7 wherein the flow channel comprises a round pipe, and the flow channel opening comprises a curved rectangular opening on a side of the pipe.

9. The device of example 8 wherein the piston covers the curved rectangular opening responsive to zero fluid flow velocity.

10. A system comprising:

an air cleaner to clean air in an airflow through the air cleaner;

a flow channel having a first end to receive airflow and a second end to exhaust fluid flow, the flow channel having a flow channel opening positioned in the airflow through the air cleaner;

a piston disposed within the flow channel, the piston having a piston passage to allow airflow through the piston; and

a spring coupled to the piston and coupled to the flow channel, the spring positioned to allow the piston to move responsive to airflow velocity in the flow channel, wherein the piston moves to modulate airflow through the flow channel opening.

11. The system of example 10 wherein the piston moves responsive to the airflow velocity to maintain exhaust airflow velocity within a desired range.

12. The system of any of examples 10-11 wherein the piston moves responsive to higher velocity airflow to cover less of the flow channel opening such that more air flows out the flow channel opening.

13. The system of any of examples 10-12 wherein the piston moves responsive to lower velocity airflow to cover more of the flow channel opening such that less air flows out the flow channel opening.

14. The system of any of examples 10-13 and further comprising a particulate matter sensor supported in the flow channel proximate the second end such that the particulate matter sensor is in the exhaust airflow.

15. The system of example 14 wherein the particulate matter sensor is an infra-red based particulate matter sensor for sensing at least 2.5 μm particles.

16. The system of example 14 wherein the particulate matter sensor is a laser based particulate matter sensor for sensing at least 2.5 μm particles.

17. A method comprising:

receiving variable velocity air flowing through an air cleaner;

modulating the velocity of the received variable velocity air to provide substantially constant velocity air to a particulate matter sensor;

sensing the particulate matter in the substantially constant velocity air; and

returning the constant velocity air to the air cleaner.

18. The method of example 17 wherein modulating the velocity of the received variable velocity air comprises:

moving a hollow piston responsive to an air pressure of the received variable velocity air;

exposing the variable velocity air to an opening responsive to moving of the piston;

exhausting variable velocity air via the exposed opening; and

providing the substantially constant velocity air through the hollow piston to the particulate matter sensor.

19. The method of example 18 wherein the hollow piston moves responsive to a spring coupled to the hollow piston.

20. The method of any of examples 18-19 wherein variable velocity air with a higher pressure moves the piston further to expose more of the opening to exhaust more variable velocity air.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A device (100) comprising:
a flow channel (115) having a first end (120) to receive fluid flow (122) and a second end (125) to exhaust fluid flow (127), the flow channel (115) having a flow channel opening (135);
a piston (130) disposed within the flow channel (115), the piston (130) having a piston passage (140) to allow airflow through the piston (130); and
a spring (132) coupled to the piston (130) and coupled to the flow channel, the spring positioned (132) to allow the piston (130) to move responsive to fluid flow velocity in the flow (105) channel, wherein the piston (130) moves to modulate fluid flow through the flow channel opening (135).

2. The device (100) of claim 1 wherein the piston (130) moves responsive to the fluid flow velocity to maintain exhaust fluid flow (127) velocity within a desired range.

3. The device (100) of claim 1 wherein the piston (130) moves responsive to higher velocity fluid flow to cover less of the flow channel opening (135) such that more fluid flows out the flow channel opening (135).

4. The device (100) of claim 1 wherein the piston (130) moves responsive to lower velocity fluid flow to cover more of the flow channel opening (135) such that less fluid flows out the flow channel opening (135).

5. The device (100) of claim 1 and further comprising a particulate matter sensor (110) supported in the flow channel (115) proximate the second end such that the particulate matter sensor (110) is in the exhaust fluid flow (127).

6. The device (100) of claim 5 wherein the particulate matter sensor (110) is an infra-red based particulate matter sensor for sensing at least 2.5 μm particles.

7. The device (100) of claim 5 wherein the particulate matter sensor (110) is a laser based particulate matter sensor for sensing at least 2.5 μm particles.

8. The device (100) of claim 1 wherein the flow channel (115) comprises a round pipe, and the flow channel opening (135) comprises a curved rectangular opening on a side of the pipe.

9. The device (100) of claim 8 wherein the piston (130) covers the curved rectangular opening responsive to zero fluid flow velocity.

10. A system (300) comprising:
an air cleaner (315) to clean air in an airflow through the air cleaner;
a flow channel (115) having a first end to receive airflow (320) and a second end to exhaust fluid flow (315), the flow channel (115) having a flow channel opening (135) positioned in the airflow through the air cleaner (315);
a piston (130) disposed within the flow channel (115), the piston (130) having a piston passage (140) to allow airflow through the piston (130); and
a spring (132) coupled to the piston (130) and coupled to the flow channel (115), the spring (132) positioned to allow the piston (130) to move responsive to airflow velocity in the flow channel (115), wherein the piston moves to modulate airflow through the flow channel opening (135).

11. The system (300) of claim 10 wherein the piston (130) moves responsive to the airflow velocity to maintain exhaust airflow velocity within a desired range.

12. The system (300) of claim 10 and further comprising a particulate matter sensor (110) supported in the flow channel proximate the second end such that the particulate matter sensor is in the exhaust airflow.

13. A method (400) comprising:
receiving (410) variable velocity air flowing through an air cleaner (315);
modulating (420) the velocity of the received variable velocity air to provide substantially constant velocity air to a particulate matter sensor (110);
sensing (430) the particulate matter in the substantially constant velocity air; and
returning (440) the constant velocity air to the air cleaner (315).

14. The method (400) of claim 13 wherein modulating (420) the velocity of the received variable velocity air comprises:
moving a hollow piston (130, 140) responsive to an air pressure of the received variable velocity air;
exposing the variable velocity air to an opening (135) responsive to moving of the piston;
exhausting variable velocity air via the exposed opening (135); and
providing the substantially constant velocity air through the hollow piston (130, 140) to the particulate matter sensor (110).

15. The method (400) of claim 13 wherein the hollow piston (130, 140) moves responsive to a spring (132) coupled to the hollow piston (130, 140).
